(19) United States
(12) Patent Application Publication
(10) Pub. No.: US 2010/0075199 A1
(43) Pub. Date: Mar. 25, 2010

(54) HYDROPHOBIC LAYER FOR A FUEL CELL

(76) Inventor: Robert M. Darling, South Windsor, CT (US)

Correspondence Address: CARLSON, GASKEY & OLDS, P.C., 400 WEST MAPLE ROAD, SUITE 350, BIRMINGHAM, MI, 48009, US

(21) Appl. No.: 12/517,077

(22) PCT Filed: Dec. 20, 2006
(86) PCT No.: PCT/US06/62350

§ 371 Date: Jun. 1, 2009

(51) Int. Cl. H01M 2/00; B05D 5/12

(52) U.S. Cl. 429/34; 427/115

(57) ABSTRACT

A device for managing fluid flow within a fuel cell assembly (24) includes a water transport plate (42) having a plurality of channels (44) and a rib (48) on each side of each channel (44). At least some of the ribs (48) have a hydrophobic layer (46) near an end of the ribs (48). The hydrophobic layer (46) in a disclosed example is adjacent a gas diffusion layer (38) associated with a cathode catalyst layer (34). One example use of the example hydrophobic layer (46) is to prevent water movement into pores of the cathode catalyst layer during cold temperature conditions.

### BACKGROUND

Fuel cell assemblies are well known. Some fuel cells include a polymer electrolyte membrane (PEM) between porous carbon electrodes containing a platinum-based catalyst in many examples. A gas diffusion layer is adjacent each electrode. Gas diffusion layers may comprise substantially uniform porosity, or may have two or more layers of differing porosity (e.g. a bi-layer). One of the electrodes operates as an anode while the other operates as a cathode. A porous separator plate, referred to as a water transport plate, is positioned against each gas diffusion layer. Water transport plates are typically hydrophilic and permit through-plane movement of water but have a pore size and structure so as to restrict through-plane transfer of gases. The through-plane movement of water permits membrane hydration and enables removal of the product water generated from the electrochemical reaction. Water transport plates may have at least a porous section, or the entire plate may be porous. The water transport plates may include channels allowing reactant fluid flow to facilitate the electrochemical reaction of the fuel cell for generating electricity. Some fuel cell assemblies use water transport plates in combination with solid separator plates.

Under some operating conditions, fuel cell performance may be compromised. For example, when a PEM fuel cell is used in cold environments, some of the cells of a cell stack assembly may be subject to decay and degraded performance after the assembly has been started at a temperature below the freezing point of water. Such operating conditions are believed to be the result of movement of water into the small pores of the cathode catalyst layer under the temperature gradient that is present during freezing conditions.

It would be desirable to avoid such performance degradation.

### SUMMARY

An exemplary device for managing fluid flow in a fuel cell includes a water transport plate having a plurality of channels and a plurality of ribs between the channels. A hydrophobic layer is near an end of at least some of the ribs.

An exemplary fuel cell includes a cathode layer adjacent to a gas diffusion layer. A water transport plate is adjacent to the gas diffusion layer. A hydrophobic layer is between at least a portion of the water transport plate and the gas diffusion layer.

In one example, a cell stack assembly includes a plurality of fuel cells each having a cathode layer, gas diffusion layer and water transport plate. At least one of the fuel cells near an anode end of the cell stack assembly includes the hydrophobic layer between at least a portion of the water transport plate and the gas diffusion layer that is adjacent the cathode layer.

An exemplary method of making a device that is useful for managing fluid flow in a fuel cell includes positioning a hydrophobic layer between a water transport plate and a gas diffusion layer on at least a cathode side of a fuel cell.

The various features and advantages of disclosed examples will become apparent to those skilled in the art from the following detailed description. The drawings that accompany the detailed description can be briefly described as follows.

### BRIEF DESCRIPTION OF THE DRAWINGS

FIG. 1 schematically shows a fuel cell stack assembly.

FIG. 2 schematically shows an example fuel cell designed according to an embodiment.

FIG. 3 schematically shows a perspective view of one example implementation of a hydrophobic layer and a water transport plate.

FIG. 4 schematically illustrates one example method of making a device designed according to an embodiment.

FIG. 5 schematically illustrates another example method of making a device designed according to an embodiment.

FIG. 6 schematically illustrates another example method of making a device designed according to an embodiment.

FIG. 7 schematically illustrates an example hydrophobic layer designed according to an embodiment.

### DETAILED DESCRIPTION

Disclosed example devices include a hydrophobic layer that is useful for managing fluid flow within a fuel cell assembly. The disclosed examples are useful, for example, to control water movement into the small pores of a cathode catalyst layer during cold temperature conditions. The disclosed examples are useful, for example, for preventing such water movement for avoiding performance decay even when a fuel cell assembly operates under conditions where the assembly starts at a temperature below freezing.

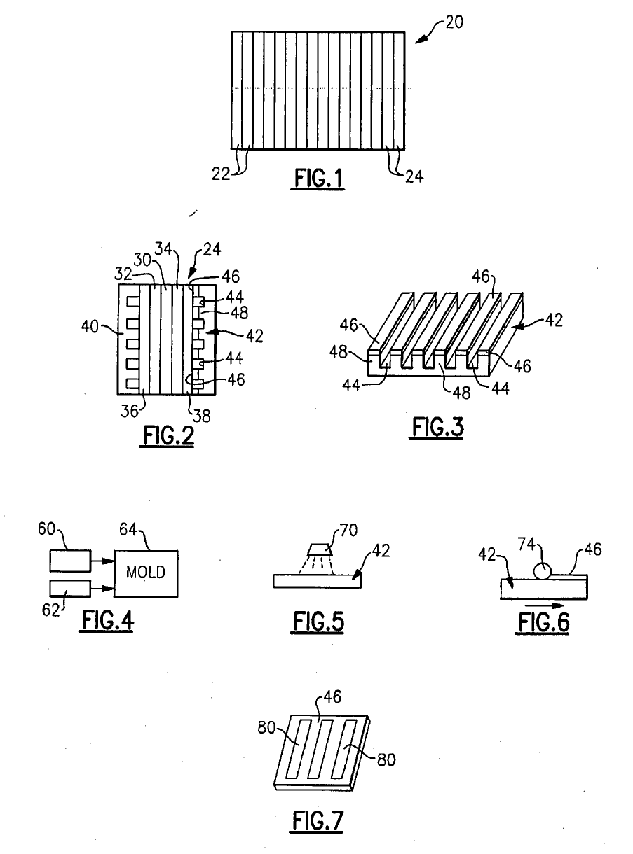

FIG. 1 schematically shows a fuel cell stack assembly 20 including a plurality of fuel cells. Some of the fuel cells 22 are near a cathode end of the cell stack assembly 20. Other fuel cells 24 are at the anode end of the cell stack assembly. At least one of the fuel cells 24 near the anode end of the example cell stack assembly 20 includes a unique device for managing fluid flow within the corresponding fuel cell 24.

FIG. 2 schematically illustrates selected portions of an example fuel cell assembly 24. In this example, a polymer electrolyte membrane 30 is positioned between an anode electrode layer 32 and a cathode electrode layer 34. A gas diffusion layer 36 is adjacent the anode electrode layer 32 while a gas diffusion layer 38 is adjacent the cathode electrode layer 34. The example fuel cell assembly 24 operates using an electrochemical reaction in a known manner for generating electricity.

The illustrated example includes a water transport plate 40 adjacent the gas diffusion layer 36 on the anode side of the example assembly 24. Another water transport plate 42 is adjacent the gas diffusion layer 38 on the cathode side of the fuel cell assembly 24. In one example, the water transport plates are porous. The example water transport plate 42 includes a body made at least partially of a known porous material useful for water transport plates. A plurality of channels 44 are formed within the body of the water transport plate 42. The channels 44 are useful for fluid flow (e.g., reactant flow to the electrode layers) during operation of the fuel cell assembly 24, for example.

In this example, a hydrophobic layer 46 is near an end of at least some ribs 48 that are between the channels 44. The ribs 48 establish one side of the illustrated example water transport plate 42 facing adjacent the gas diffusion layer 38. The hydrophobic layer 46 is provided along the outermost edge of each rib 48 in this example.

As can be best appreciated from FIG. 3, the hydrophobic layer 46 establishes a hydrophobic barrier between corresponding portions of the water transport plate 42 and the gas diffusion layer 38. The hydrophobic layer 46 prevents any water from the water transport plate 42 from migrating into the gas diffusion layer 38 and the small pores of the cathode catalyst layer 34 during freezing conditions, for example. The hydrophobic layer 46, therefore, prevents the type of fluid movement within the fuel cell assembly 24 that is believed to be the cause of fuel cell performance degradation associated with starting such a fuel cell during freezing conditions.

In the illustrated examples, hydrophobic layer 46 follows at least some of the ribs 48. In other words, the illustrated example hydrophobic layer 46 has the same flow field pattern as the water transport plate 42.

The example fuel cell stack assembly 20 of FIG. 1 includes at least one fuel cell assembly 24 having a hydrophobic layer 46. In some examples, a plurality of the fuel cells 24 near the anode end of the cell stack assembly 20 include the hydrophobic layer 46. By providing an appropriate number of fuel cells within a cell stack assembly near at least the anode end that include a hydrophobic layer like that of the illustrated embodiments will prevent the type of water movement within at least those fuel cells and, therefore, improve fuel cell performance. Those skilled in the art who have the benefit of the description will realize how many fuel cells with a hydrophobic layer will best meet their particular needs.

In one example, the hydrophobic layer 46 is established as part of the water transport plate 42. FIG. 4 schematically illustrates one example method of making such a device. In this example, a material supply 60 that provides the material of the body of the water transport plate 42 and a material supply 62 of the material used for the hydrophobic layer 46 are both provided into a mold 64 in a manner that allows the water transport plate 42 to be molded with the hydrophobic layer 46 near the ends of the ribs 48 that will be placed adjacent a gas diffusion layer within a fuel cell. Depending on the material selection, various molding techniques are possible. Given this description, those skilled in the art will realize how best to arrange a molding operation to achieve a water transport plate having an integrated hydrophobic layer 46 to meet the needs of their particular situation.

FIG. 5 schematically illustrates another example method of establishing a hydrophobic layer 46. In this example, an applicator 70 applies the hydrophobic layer to the body of the water transport plate 42. In one example, the hydrophobic layer is sprayed onto the body of the water transport plate prior to establishing the channels 44. Portions of the water transport plate body will be machined to establish the channels 44 in a known manner. In such an example, the hydrophobic layer material will be machined away in the position where the channels 44 are established. The hydrophobic layer 46 will remain on the other portions (e.g., the ribs 48).

In another example, the water transport plate 42 already has the channels 44 established prior to the hydrophobic layer 46 being sprayed onto the ribs 48. In such an example, a masking technique is used to mask the channels 44 so that the hydrophobic layer 46 is only applied to the desired portions (e.g., the ribs 48) of the water transport plate 42.

In another example, the applicator 70 brushes on a hydrophobic layer. In another example, the applicator 70 comprises a roller.

FIG. 6 schematically illustrates another example method of establishing a hydrophobic layer 46 on a water transport plate 42. In this example, a supply 74 such as a roll provides one or more strips that are applied to the water transport plate 42 to embellish the hydrophobic layer 46. Some examples include only applying strips of the hydrophobic layer 46 onto the ribs 48 of the water transport plate 42. Depending on the selected materials, various techniques for securing the hydrophobic layer to the water transport plate may be used.

FIG. 7 schematically illustrates another example arrangement where the hydrophobic layer 46 comprises an independent piece of hydrophobic material. In this example, a plurality of openings or channels 80 are established in a layer of hydrophobic material and the openings 80 are aligned with the channels 44 of the water transport plate 42 within the fuel cell assembly 24.

A variety of materials may be used for the hydrophobic layer. One example includes polytetrafluoralethylene, which is commercially available under the trademark TEFLON®. Given this description, those skilled in the art will realize what type of hydrophobic material will best meet their particular needs.

The preceding description is exemplary rather than limiting in nature. Variations and modifications to the disclosed examples may become apparent to those skilled in the art that do not necessarily depart from the essence of this invention. The scope of legal protection can only be determined by studying the following claims.

1. A device for managing fluid flow within a fuel cell, comprising:
a water transport plate having a body that includes a plurality of channels and a plurality of ribs between the channels, the water transport plate having a flow field pattern corresponding to the plurality of channels and the plurality of ribs; and
a hydrophobic layer near an end of at least some of the ribs, the hydrophobic layer having a flow field pattern that is the same as the flow field pattern of the water transport plate.

2. The device of claim 1, comprising
the hydrophobic layer near an end of each of the ribs.

3. The device of claim 1, wherein the hydrophobic layer is secured to the at least some of the ribs.

4. The device of claim 1, wherein the hydrophobic layer comprises a portion of the water transport plate.

5. The device of claim 1, wherein the hydrophobic layer comprises a distinct piece of material independent of the water transport plate.

6. A fuel cell assembly, comprising:
a cathode catalyst layer;
a gas diffusion layer having one side adjacent the cathode catalyst layer;
a water transport plate adjacent an opposite side of the gas diffusion layer, the water transport plate having a flow field pattern; and
a hydrophobic layer between at least a portion of the water transport plate and the gas diffusion layer, the hydrophobic layer having a flow field pattern that is the same as the flow field pattern of the water transport plate.

7. The assembly of claim 6, wherein the water transport plate comprises a plurality of channels and a rib on each side of each of the channels; and
wherein the hydrophobic layer is near an end of at least some of the ribs.

8. The assembly of claim 7, wherein the hydrophobic layer is near an end of each of the ribs.

9. The assembly of claim 6, comprising
a plurality of fuel cells within a cell stack assembly, some of the fuel cells being near a cathode end of the cell stack assembly and others of the fuel cells being near an anode end of the cell stack assembly, at least one of the fuel cells near the anode end of the cell stack assembly including the hydrophobic layer.

10. The assembly of claim 9, comprising a plurality of fuel cells near the anode end of the cell stack assembly that each include a hydrophobic layer between the corresponding gas diffusion layer and water transport plate.

11. The assembly of claim 6, wherein the hydrophobic layer is secured to the at least some of the ribs of the water transport plate.

12. The assembly of claim 6, wherein the hydrophobic layer comprises a portion of the water transport plate.

13. The assembly of claim 6, wherein the hydrophobic layer comprises a distinct piece of material independent of the water transport plate.

14. A method of making a device that is useful for managing fluid flow within a fuel cell, comprising:
establishing a hydrophobic layer near an end of at least some ribs of a water transport plate, such that the hydrophobic layer has a flow field pattern that is the same as a flow field pattern of the water transport plate.

15. The method of claim 14, comprising molding the hydrophobic layer as a portion of the water transport plate.

16. The method of claim 14, comprising applying the hydrophobic layer to at least selected portions of the water transport plate.

17. The method of claim 16, comprising spraying a hydrophobic material onto the at least selected portions of the body of the water transport plate.

18. The method of claim 16, comprising securing a layer of hydrophobic material onto the selected portions of the water transport plate.

19. The method of claim 14, comprising forming a hydrophobic material layer independent of the water transport plate; and
placing the independent hydrophobic layer adjacent the water transport plate.

20. The method of claim 19, comprising establishing a flow field pattern of the hydrophobic layer that corresponds to a flow field pattern of the water transport plate.
